(19) United States
(12) Patent Application Publication
(10) Pub. No.: US 2007/0150372 A1
(43) Pub. Date: Jun. 28, 2007

(54) Vendor and Consumer Matching

(76) Inventor: Roy Schoenberg, Boston, MA (US)

Correspondence Address: MINTZ, LEVIN, COHN, FERRIS, GLOVSKY;AND POPEO, P.C., ONE FINANCIAL CENTER, BOSTON, MA, 02111, US

(21) Appl. No.: 11/612,983

(22) Filed: Dec. 19, 2006

Related U.S. Application Data
(60) Provisional application No. 60/752,819, filed on Dec. 19, 2005.

(51) Int. Cl. G06Q 30/00

(52) U.S. Cl. 705/26

(57) ABSTRACT

A system for use as an intermediary between products vendors and consumers of products includes an input subsystem adapted for receiving product opportunity information from a vendor, and a selection engine adapted to access and process the product opportunity information and consumer information to associate the product opportunity with at least one consumer. The selection engine is adapted to connect to a source of consumer information over a network.

### BACKGROUND

In the past, the matching of a consumer to a specific opportunity (e.g., a clinical trial) provided by a vendor was the responsibility of the individual vendor itself. For example, a pharmaceutical company running a clinical trial would have to expend significant time, effort, and money to contact individual providers and physicians to try to find individual candidates to participate in their clinical study. Likewise, if a company developed a new product, the company typically had to expend time and money to market the product through the typical retail sales channels, (e.g., through individual stores like CVS and Eckerd), or contact individual physicians to publicize the availability and capabilities of the new product.

Legislation in the healthcare market and/or other markets can pose significant limitations on the process of utilizing consumer information to direct services and product offerings. One concern is the disclosure and possible abuse of the consumer's information rather than its use to refine and better coordinate services/promotions to the consumer. Thus, a physician is unable to reveal the details of the consumer's medical history to the vendor running the clinical trial. Without disclosing the medical history of a particular consumer to the vendor, the vendor is unable to determine if a consumer is suited for a particular clinical trial (or other product or service) being offered by the vendor.

### SUMMARY

The invention is directed to a method of operation and system that operates as an intermediary between vendors offering products and consumers of those products including an input subsystem adapted for receiving product opportunity information from the vendor, a selection engine adapted to access and process the product opportunity information and consumer information to associate the product opportunity information with at least one consumer, and the selection engine is adapted to connect to a source of consumer information over a network. In accordance with the invention, the system can preserve the security and confidentiality of the consumer information because the selection of consumers can occur without giving the vendor access to the consumer's private or confidential information.

Various aspects of the invention may provide one or more of the following capabilities. For example, the system can serve as a broker that stands between one or more healthcare management/delivery entities that stores confidential consumer (health or other) information (e.g., a Blue Cross or other health plan, a hospital or other health care provider), one or more consumers, (e.g., a patient) and one or more vendors (e.g. a pharmaceutical company looking for eligible members for a clinical trial). The system can use private and confidential consumer profile information available from service providers that have an existing relationship with the consumer, (e.g. a portal or data system) to match and broker available vendor opportunities to consumers while substantially maintaining consumer privacy and preserving the security of the information.

These and other capabilities of the invention, along with the invention itself, will be more fully understood after a review of the following figures, detailed description, and claims.

### BRIEF DESCRIPTION OF THE FIGURES

FIG. 1 is a simplified conceptual diagram of an intermediary system according to the invention.

FIG. 2 is a simplified network diagram of an intermediary system according to the invention.

### DETAILED DESCRIPTION

This invention relates to the promotion of goods and services to consumers, where consumers are, for example, patients in a healthcare system and/or consumers of other providers. Specifically, the invention relates to an intermediary system that can match and present opportunities (e.g., products, services, and/or clinical trials) offered by a vendor (e.g., pharmaceutical companies, insurance companies, healthcare product providers, healthcare providers, public health systems, private health systems, etc.) to consumers. In many cases, the consumers are associated with a healthcare provider, and/or a health plan, (e.g., Aetna, Blue Cross Blue Shield, a state government health system, etc.), or any other modality used by such entities that collects the pertinent data (e.g., financial claim systems, predictive modeling systems, enrollment/eligibility systems, etc.). The matching function can be flexible. It may not be required that a selected consumer meet all the requirements specified by the vendor. For example it can be sufficient that the consumer meet a subset of the requirements specified by the vendor. In addition, each requirement can include a range or a tolerance or threshold such that the consumer meets the requirement if they fall within the range or tolerance or exceed the threshold.

The term “product” is intended to include both goods and services in this disclosure. The term healthcare is intended to include healthcare products and healthcare services. Healthcare providers is intended to include providers of healthcare, including, for example, doctors, hospitals, and health plans. In some cases, an entity that is a source of consumer health information can also be a vendor, for example, a hospital can be both a healthcare vendor (e.g., offering clinical trials) and a healthcare provider that is a source of consumer healthcare information. Product opportunity information can include information about the product or service offered as well as the terms and conditions of the offer, for example who is eligible and what requirements need to be met. A consumer profile can be an ordered subset of consumer information while a consumer characteristic can be one of the items or attributes that make up the profile.

One function of the intermediary system can be to serve as a broker that stands between one or more care management/delivery entities (e.g., a Blue Cross plan), one or more consumers, (e.g., a patient) and one or more vendors (e.g. a pharmaceutical company looking for eligible members for a clinical trial). The intermediary can use consumer profile information available from the healthcare provider, plan, or insurer (e.g. a portal or data system) to match and present available vendor opportunities to consumers while substantially maintaining consumer privacy.

Consumers can benefit from the invention because it can provide them with access to specific information about a product that is targeted specifically to them, based on information (consumer profiles) securely hosted by a data collection system, such as a health portal provided by a healthcare provider. For example, some healthcare providers operate health portals that are used for many purposes, such as individual case management. A consumer can log on to a health portal and provide, using various methods, information related to their health status (e.g., prescription drug information, existing medical conditions, family medical history, clinical tracking, risk assessments, etc.). Vendors typically do not have access to such information due to privacy regulations and the complexity associated with interacting with the plan's data systems. Thus, the intermediary system can provide a method of and a system for matching a specific consumer to a vendor offering, without disclosing the consumer's private information to the vendor. The matching process can take place in either the intermediary system or directly at the level of the system where the data originates or is natively processed.

For example, the intermediary system can modify portions of the consumer's profile to indicate that an opportunity is available. In some cases, the consumer's profile can include a private portion and a non-private portion and the intermediary can use the private portion for the matching process and can modify the non-private portion, or add a note to it, to indicate that an opportunity is available. In this example, the healthcare portal, upon checking the consumer's profile, such as when they log into the portal, can notify the consumer of the opportunity.

Consumers can be notified of opportunities that are relevant to their specific healthcare needs. For example, a consumer can be notified of certain opportunities relevant to their condition (e.g., a clinical trial looking for consumers with the same symptoms as the consumer), products designed for people in a similar condition as the consumer (e.g., a new glucose test strip aimed at diabetics), prescription drugs at reduced prices, specifically applicable services (e.g., physiotherapy for patients with mobility issues), etc. As noted above, in some embodiments, the healthcare provider can include a “profiling engine” that is responsible for analyzing data provided by a consumer and/or developed as a result of the consumer's use of their systems (e.g. a health portal) to determine if the consumer is a good match for the products or services of one or more vendors. In other embodiments, the healthcare provider can, through the use of the profiling engine, provide consumer information to the intermediary system, which can include a “selection engine” that is responsible for analyzing the consumer information and the product opportunity information to identify consumers to be associated with at least one product opportunity as a function of the opportunity characteristics and the consumer characteristics.

The invention relates to the creation of an intermediary system that can provide a vendor with the ability to promote their opportunities to consumers without sharing the consumer's personal information with the vendor. The intermediary system can provide indirect access to consumers using information that vendors do not generally have access to such as a consumer's medical history or website profile. The intermediary system receives from a vendor a specification or profile of the desired or preferred characteristics of a consumer that the vendor is trying to locate. For example, a person with a family history of cardiac problems may be the ideal candidate for clinical study of a new preventative drug aimed at reducing the risk of heart-attacks. In some embodiments, the intermediary system can interact with the profiling engine of the healthcare provider entity and use the selection engine of the intermediary system to identify particular consumers that are a match with the vendor's prerequisites. Once the intermediary system identifies a match between a consumer and a vendor, the intermediary and/or the entity managing the consumer data/services (e.g. a health plan) can contact the consumer and advise them of the available opportunity (e.g., that a particular clinical trial, service, and/or product may meet their needs). The message provided by the intermediary and/or the health portal to the consumer may occur using different methods and/or technologies, and is not limited to any particular mode of communication. In addition, the consumer may indicate to the portal or to the healthcare provider how he or she would like to be contacted, if at all. The message can be provided to a consumer from the intermediary system, or it can be provided by the system that is deployed by the healthcare provider to interact with the consumer. For example, the intermediary system can send data to a portlet operating on a Web-based health portal that a consumer is using. The intermediary system can utilize multiple means to capture mind share of the targeted consumer using media (e.g. websites) operated by the entity (healthcare provider). The intermediary system can place a phone call to the consumer. The intermediary system can send a fax, an e-mail, a text message, an SMS message, and/or a letter to the consumer. The intermediary system can dispatch a person to attempt in-person contact with the consumer. Furthermore, the intermediary system can inform the company operating the health portal to contact the consumer. For example, health portal operators themselves can send data to a portlet operating on a Web-based health portal that the consumer is using, based on information provided by the intermediary system. The health portal operator, using their own systems, can cause a window to open or “pop-up,” or a Web-page frame to appear on a computer that the consumer is using. The health portal operator can place a phone call to the consumer. The health portal operator can send a fax, an e-mail, a text message, an SMS message, and/or a letter to the consumer. The health portal operator can dispatch a person to attempt in-person contact with the consumer. Other modes of communication to the consumer can be used.

In practice, a vendor can work with the intermediary system to identify and establish the characteristics of consumers it wishes to offer products to. The vendor is then responsible to work with the web portal operators (e.g. a health plan operating a web portal and consumer mind-share owners) to identify such consumers and facilitate the process that will lead to the exercising of the opportunity surrounding the vendor offer. As described above, the intermediary system can be (but is not necessarily) responsible for providing a visual presentation of an available opportunity to a targeted consumer. For example, the intermediary system allows a vendor to have “real estate” in a healthcare provider's portal, such as a two-inch square within a web-page, that will establish a touch point. The intermediary system can have full control over the content of the two-inch square, even though it is operating on a website controlled by the healthcare provider. Alternatively, the operator of the medium (e.g., the plan operating the portal) can control the rendering as a service to its membership.

The intermediary system can function as an independent operation in the sense that the intermediary system is the entity that enables the matching of a vendor's opportunity (e.g., a clinical trial, product, and/or service) with a specific consumer, rather than the vendor or the healthcare provider attempting to accomplish the matching. That the intermediary system is a third party (e.g., not the consumer's physician or health insurance provider) may enhance the value, to the consumer and/or the vendor, of a match made by the intermediary system. For example, many consumers do not want to feel like their physician is promoting a product. Rather, consumers typically like to think that the physician is a truly independent source of medical advice. Using the intermediary system, the healthcare provider and the physician can remain disinterested and strengthen the apparent value of a recommendation made to a consumer. Furthermore, in some circumstances, it may be inappropriate (by regulation or law) for a healthcare provider to make a recommendation of a particular product or service.

The consolidation of the brokering process allows the intermediary to offer benefits that stem from the economies of scale of this model. As such, broadcasting an offering to a highly-targeted consumer population over a multi-plan scope may result in a lower cost to the end consumer (e.g., due to reduced marketing cost for the vendor). The ability of the plan to offer reduced costs for endorsed products and/or services that address the core needs of their membership (e.g., glucometers for diabetics, orthopedic devices for members with a disability, Lasik surgery for members with Myopia, etc.) can enhance the value of the plan's offering (“benefit”) to both the end-consumers as well as the plan's customers (e.g., employers). Examples of benefits of the brokering system according to the invention are:
1. Vendor—A low-cost method to gain access to a large scope of likely consumers.
2. Plan/care entity—An ability to promote needed services at lower costs as a benefit enhancing service. An ability of the plan/care entity to deliver diversified (non-plan) services over their own portals to gain higher portal adoption.
3. Consumer—Access to products and/or services at reduced cost. Access to timely opportunities that the consumer would otherwise be unlikely to know about (e.g. clinical trials) and/or unlikely to pursue without prior validation of the consumer's eligibility.

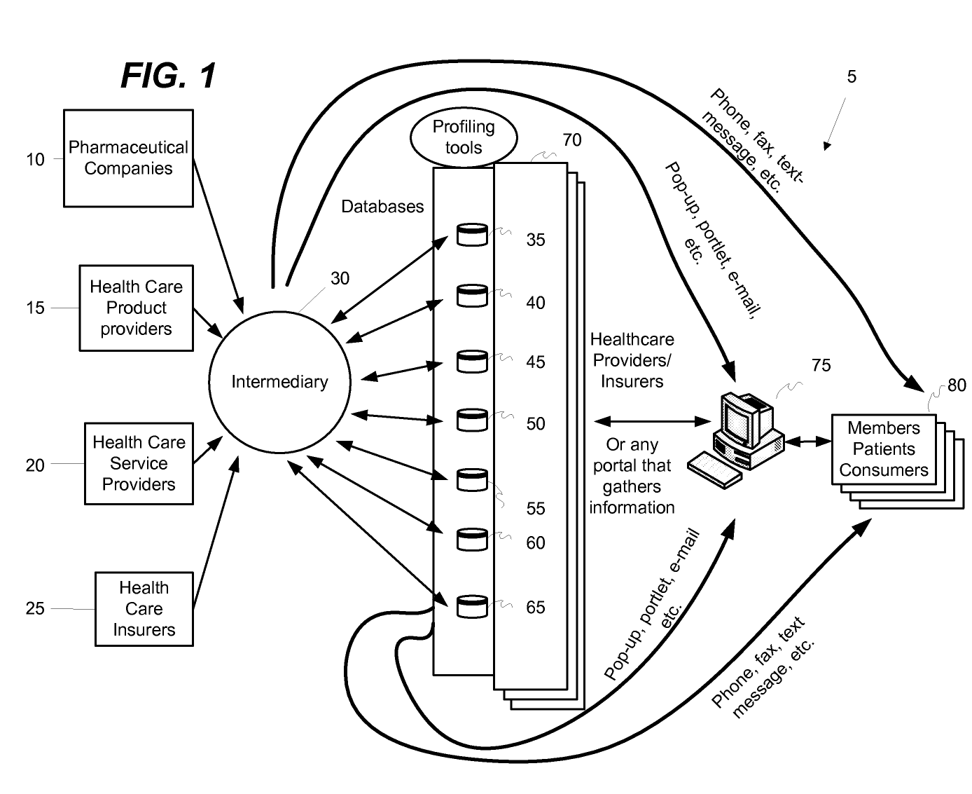

Referring to FIG. 1, a system 5 includes vendors 10, 15, 20, and 25, an intermediary 30, databases 35, 40, 45, 50, 55, 60, and 65, healthcare providers 70, a Web-interface 75, and consumers 80. The vendors 10, 15, 20, and 25 can be companies or commercial entities that want to identify and contact consumers having specific needs or characteristics. The vendors 10, 15, 20, and 25 can be companies offering opportunities such as a product and/or a service (e.g., a clinical trial). The healthcare providers 70 typically have one or more method's of interaction with the consumers 80 such as a Web-based interface, or telephone-based interface. One example of the method of interaction is the healthcare portal website. The information gathered by the healthcare providers can be stored in, for example, the databases 35, 40, 45, 50, 55, 60, and 65. A profiling engine (not shown in FIG. 1) can convert the raw data input by the consumers 80 or gathered by the website into individual profiles, which are stored in one or more of the databases 35, 40, 45, 50, 55, 60, and 65.

The intermediary 30 can be a system, such as a computer system, that can interact with the vendors 10, 15, 20, and 25 and one or more of the databases 35, 40, 45, 50, 55, 60, and 65. The intermediary 30 can receive information about product opportunities (e.g., clinical trials, products, and/or services) and likely characteristics of consumers of those opportunities (e.g., clinical trials, products, and/or services) from the vendors 10, 15, 20, and 25, and has the ability and the technology to interface with and translate, as necessary, the profile data generated, gathered, and stored by the healthcare provider (e.g., by a profiling engine) into a form the intermediary system can use to match opportunities to consumers (e.g., by a selection engine). In alternative embodiments, the intermediary system may have a profiling engine to generate a consumer profile from raw data from the healthcare provider. The intermediary system can send a message to a portion of the health plan portal that the intermediary controls, such as a portlet. The intermediary 30 can interact and offer services to the consumers 80 in a way that does not violate the consumer's privacy by providing information to either the intermediary system operator or the vendors 10, 15, 20, and 25. The consumer's privacy can be preserved through various means. If, as in one of the above described embodiments, the consumer information/profiles reside at the healthcare provider 70, then the matching process performed by the intermediary system 30, can be a blind or anonymous process with the intermediary system 30 never having knowledge of the consumer's identity. If, the consumer information is transmitted from the healthcare provider 70 to the intermediary system 30 to perform the matching or association process, then the consumer's identity and contact information can be encrypted with the healthcare provider 70 holding the encryption key. This can allow the intermediary system 30 to associate the vendor product opportunity information with consumers, without being able to unlock and disclose the consumer information for any other purposes which could potentially result in abuse of that confidential information. The intermediary 30 can be an entity and/or system that brokers information between the vendors 10, 15, 20, and 25 and the consumers 80, and is independent from the healthcare provider 70 and the vendors 10, 15, 20, and 25. The intermediary 30 can have the capability to provide a channel to promote a product and/or a service through multiple healthcare providers 70.

Using the intermediary in accordance with the invention can reduce the costs associated with targeting specific consumers, which can ultimately translate into cost-savings for the vendors and/or consumers. The additional services provided by the intermediary can enhance the value of a health portal to consumers, thereby encouraging more consumers to use a particular health-portal. For example, if a consumer knows that a particular health portal will provide targeted information of value, the consumer may be more prone to use the health portal (e.g., a consumer may be more prone to use the health portal if they knew they could find out about lower-cost drugs, health products, and/or services). If a vendor is trying to sell a particular product or service, and the intermediary provides the vendor with a channel for targeted marketing that reaches many people, the vendor may reduce its marketing costs, thereby reducing the cost of the product or service being offered. In addition, the intermediary can provide the vendor with access to many consumers because the intermediary can interact with a single healthcare provider, or many healthcare providers.

FIG. 1 is representative and not limiting. For example, there can be different quantities of vendors, intermediaries, databases, healthcare providers, web-interfaces, consumers, etc. The intermediary can communicate directly with the healthcare provider 70. The intermediary can be a computer program that is part of or separate from the health portal of a provider.

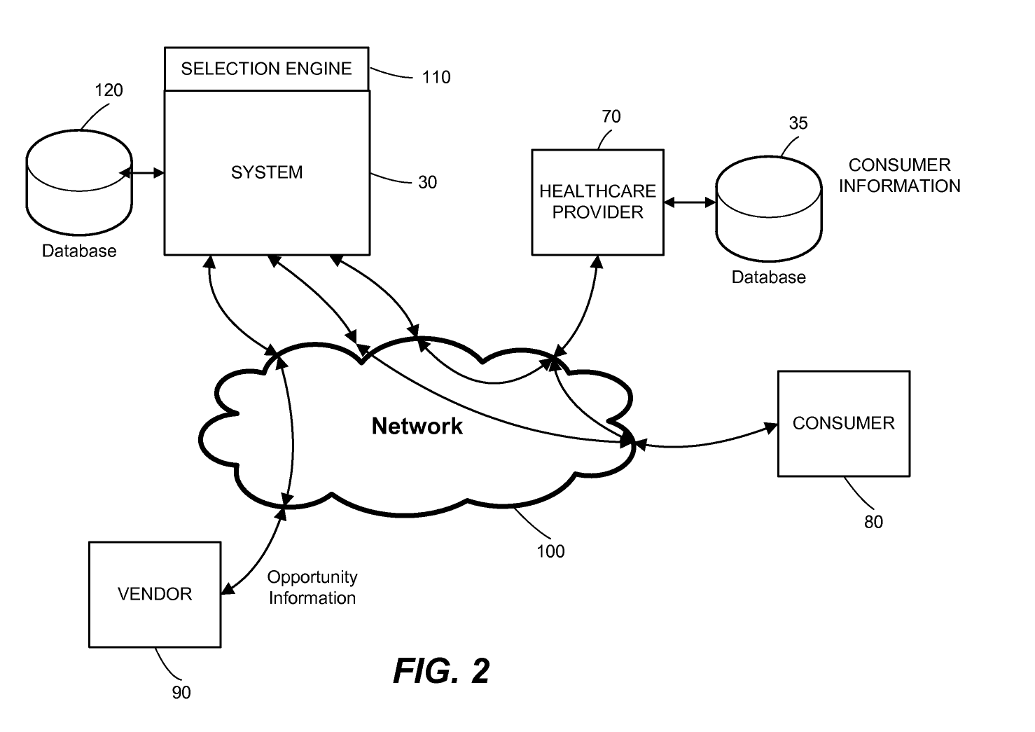

Referring to FIG. 2, a network diagram is shown which includes an intermediary system 30, a healthcare provider system 70, a consumer information database 35, a consumer 80, a vendor 90, a communications network 100, a selection engine 110, and an intermediary system database 120. Although one consumer information database 35 is shown for illustrative purposes, the quantity is representative and not limiting. The vendor 90 is a company or entity that wants to identify and contact consumers having specific needs or specific characteristics (such as a specific health condition or profile). The vendor 90 thus generates product opportunity information which it transmits to the intermediary system 30 through a network 100. Here, the network 100 is preferably a data network such as the global data network known as the Internet. The network 100 is preferably a packet-switched, wide area network (WAN). Other types of networks may be used however. The method of transmission of the opportunity information can take many forms. For example, the vendor 90 can access an intermediary system webpage to enter the opportunity information through the use of a web-based client/server standard database access input form. The intermediary system 30 can have a web-based user interface (U.I.) with several input fields to allow the vendor to identify the opportunity and the desired characteristics of the consumer. The vendor can produce and store opportunity information on its own system and then upload the opportunity information to the intermediate system. In another embodiment, the intermediary system 30 can actively pull the opportunity information from the vendor 90 through the network 100.

The healthcare provider 70 can maintain one or more databases 35 of its consumer's personal medical information, which can be used to generate consumer profiles. The healthcare provider 70 can also be connected to the communication network 100. The healthcare provider 70 can utilize the communication network 100 to communicate with the consumer 80 to both collect information and to provide information. The healthcare provider 70 can utilize the communication network 100 to provide the consumer raw data or consumer profile/information from its databases to the intermediary system 30. The healthcare provider 70 can maintain the healthcare consumer privacy since the pre-approved intermediary system 30 is the only 3^{rd} party to receive the confidential healthcare consumer information. In addition, the intermediary does not need direct access to consumer profiles and confidential consumer information. The healthcare provider can merely provide the intermediary system the ability to search the consumer profiles for specific information and provide the intermediary with an identification of a consumer or a consumer identification (ID) number, or other information useful to enable the consumer to be contacted. Where a consumer ID number is returned, the intermediary can inform the healthcare provider or portal that a given opportunity should be presented to consumers corresponding to a set of consumer ID numbers.

The method of transmission of the consumer information can take many forms. For example, the healthcare provider 70 can access an intermediary system webpage to enter the consumer information through the use of a standard web-based input form. In another embodiment, the intermediary system 30 can actively pull the consumer information from the healthcare provider 70 through the network 100.

The intermediary system 30 can contain a selection engine 110 which processes the vendor opportunity information and the consumer information to identify consumers to be associated with at least one product opportunity based on a function of the opportunity characteristics and the consumer characteristics. The intermediary system 30 can be connected to a database 120 in which the system 30 can store the vendor product opportunity information and/or consumer information. Once the intermediary system 30 has identified consumers, it can contact the consumers and provide them with the product opportunity information associated to their individual characteristics, through the communication network 100. In some embodiments, the intermediary system 30 can be a computer server running a computer readable, computer program software code instructions to perform the steps and functions described above.

While the invention is disclosed in the context of a healthcare system, the invention can be used in other industries too. This invention can apply to any industry that collects information about consumers. For example, many sports oriented websites collect information on consumers, which can be used to target specific consumers with information of interest (e.g., a particular consumer always looks for scores of a particular NFL team, so the intermediary can make the consumer aware of tickets relating to their favorite team).

While the invention has been directed at notifying a consumer of an opportunity such as a service or product, other messages can be sent. For example, a message sent to a consumer can include reminders to make check-up appointments and/or warning messages (e.g., if the consumer's profile indicates that they are at an increased risk for a particular malady).

A portlet is a sub-area of the website that can be operated and controlled by a third party as a separate component. The portlet is a functional component of a website that can be served from a different server than the hosting website. Several portlets may be called as a result of a single request of a portal page. Each portlet produces a fragment of markup that can be combined with the markup of other portlets, all within the portal page markup. Portlets can be totally different applications that are embedded in another website. Portlets have their own type of access controls and mechanisms, and have a lot of capabilities that may not be available with frames.

Portlets/web-presence can be created using, for example, JAVA, AJAX and/or other technology and can be managed by a portlet container. The portlet container requests and generates dynamic content from some third party (e.g., a party besides the user and the Web-page server). Portlets can be used as pluggable user interface components that provide a layer of presentation to an information system, such as a Web-page. The Java Specification Request 168 describes interoperability between portlets and portals. The Java Specification Request 168 is incorporated by reference herein. The content generated by a portlet is typically referred to as a fragment, a piece of markup (e.g., HTML, XHTML, or WML (Wireless Markup Language)) adhering to certain protocols. Multiple fragments can be combined to form a complete document. A portlet's content may be made up of several combined fragments.

While the term “invention” is used herein, the present disclosure may contain more than one invention.

The invention may be embodied in other specific forms without departing from the spirit or essential characteristics thereof. The present embodiments are therefore to be considered in respects as illustrative and not restrictive, the scope of the invention being indicated by claims rather than by the foregoing description, and all changes which come within the meaning and range of the equivalency of the claims are therefore intended to be embraced therein.

What is claimed is:

1. A system for use as an intermediary between products vendors and consumers of products comprising:
an input subsystem adapted for receiving product opportunity information from a vendor, and
a selection engine adapted to access and process the product opportunity information and consumer information to associate the product opportunity with consumers,
wherein the selection engine is adapted to connect to a source of consumer information over a network.

2. The system of claim 1 wherein the source of the consumer information is the consumer.

3. The system of claim 1 wherein the source of the consumer information is a healthcare provider database and the consumer information is private consumer information not accessible by the vendors.

4. The system of claim 1 wherein the input subsystem is further adapted to connect to a source of product opportunity information over a network.

5. The system of claim 1 wherein the input subsystem includes a web based user interface configured for receiving product opportunity information.

6. The system of claim 1 wherein the system is configured to provide the consumers with information about the associated product opportunity.

7. A system for use as an intermediary between healthcare vendors and healthcare consumers comprising:
an input subsystem adapted for receiving product opportunity information from a healthcare vendor, and
a selection engine adapted to access and process the product opportunity information and consumer healthcare information to associate the product opportunity with one or more healthcare consumers,
wherein the selection engine is adapted to connect to a source of consumer healthcare information over a network,
wherein the system is configured to contact and provide the one or more healthcare consumers with information about the associated product opportunity.

8. The system of claim 7 wherein the source of the healthcare consumer information is the healthcare consumer.

9. The system of claim 7 wherein the source of the healthcare consumer information is a healthcare provider database and the consumer information is private consumer information not accessible by the vendors.

10. The system of claim 7 wherein the input subsystem is further adapted to connect to a source of healthcare product opportunity information over a network.

11. The system of claim 7 wherein the input subsystem includes a web based user interface configured for receiving healthcare product opportunity information.

12. A method for providing a vendor with the ability to promote product opportunities to consumers without disclosure of the consumer's personal information to the vendor, comprising:
receiving vendor product opportunity information including desired consumer characteristics,
receiving consumer information including characteristics about one or more consumers,
providing a selection engine,
processing the vendor product opportunity information and the consumer information at the selection engine to identify at least one consumer to be associated with at least one product opportunity as a function of the product opportunity characteristics and the consumer characteristics, and
providing the at least one consumer with information about the at least one product opportunity that is associated with the at least one consumer.

13. A method for associating a vendor product opportunity with consumers based on a comparison of vendor product opportunity information and consumer information, comprising:
accessing vendor product opportunity information including target consumer characteristics,
accessing consumer information including characteristics about one of more consumers from a secure source, not accessible to the vendor,
processing the vendor product opportunity information and the consumer information to identify at least one consumer to be associated with at least one product opportunity as a function of the product opportunity characteristics and the consumer characteristics, and
providing the at least one identified consumer with information about at least one product opportunity associated with the at least one consumer.

14. The method of claim 13 wherein the opportunity information includes a range and a portion of the consumer information is within that range.

15. A computer readable medium comprising:
computer program instructions adapted to control a computer system to receive vendor product opportunity information and consumer information, process the vendor product opportunity information and consumer information to associate a product opportunity with one or more consumers based on a comparison of product opportunity requirements and consumer characteristics, and contact the one or more consumers with information about the associated vendor opportunities.
